(19) United States
(12) Patent Application Publication
(10) Pub. No.: US 2005/0150225 A1
(43) Pub. Date: Jul. 14, 2005

(54) Power generation by solar/pneumatic cogeneration in a large, natural or man-made, open pit

(76) Inventors: Jonathan John Gwiazda, Boston, MA (US); Francis Anthony DiBella, Roslindale, MA (US)

Correspondence Address: FRANCIS A. DiBELLA, I HASLET ST., ROSLINDALE, MA, 02131-2194, US

(21) Appl. No.: 10/752,506

(22) Filed: Jan. 8, 2004

(51) Int. Cl. F03G 7/00; F01K 27/00

(52) U.S. Cl. 60/641.1

(57) ABSTRACT

This patent describes a method for power generation combining a solar concentrator and a pneumatic power tube system. Solar energy is concentrated to solar thermal receivers by a plurality of heliostat mirrors placed along the embankment of an open pit mine. The air in the pneumatic tubes is heated by direct and/or waste heat energy recovered from a solar power system and/or from a variety of sources. The invention is novel in its integration of a solar powered heat engine and a modular design, pneumatic power tube wherein a means of structural support for the tube(s) can be provided by the geophysical surroundings. The novel design features of the power tube pit include: its use of state-of-the art wind turbine power recovery, solar reflective surfaces for solar energy collection, heat pipe arrays for ground source heat recovery and air diffuser subsystems for enhanced wind turbine efficiency.

### FIELD OF INVENTION

This invention is part of the field of power generation that uses waste heat recovery and/or natural or alternative energy sources while also serving as a form of land remediation or re-utilization. The invention is used to generate power using waste heat and solar energy from very large land areas that may otherwise be the cause of significant land remediation.

### BACKGROUND OF INVENTION

This invention is the result of a series of studies conducted by the authors that culminated in a series of papers: “A Novel Thermally Induced Draft Air Power generation System for Very tall, Man-made and natural Geo-Physical Phenomenon” (IJPGC2002-26098) by F. Di Bella and Jonathan Gwiazda, “A Novel Application of AeroElectric and Solar Power Tower Technology: ‘Pit Power Tower,” and (IJPGC2003-40071) “A New Concept for a Thermal Air Power Tube used with Concentrated Solar Energy Power Generation in Open-Pit Mines and Large Natural Geo-Physical Phenomenon.

In a preliminary study conducted by DiBella, a variety of energy generating options were studied whose common thread was their use in skyscrapers and other free standing structures that are over 1,000 ft. tall. One of the more radical ideas promoted in that paper was the use of elevator shafts to support the controlled generation of air currents due to the natural draft or “chimney” effect caused by internal columns of air that are hotter and thus less dense than the cooler, outside air. In that paper the use of elevator shafts as a “chimney” was intended as a means of reducing or eliminating the cost of constructing free standing structures that had only the purpose of thermally inducing air currents.

In the 2002 ASME paper the authors suggested that the thermal energy from the induced air chimneys could be derived from the rejected energy from the HVAC and lighting energy loads required in skyscrapers but also from solar energy concentrated on freestanding columns. The results obtained from the second study indicated that appreciable power generation (over 1 Mwe) could only be obtained if the columns were very large in diameter and overall height. The present authors made the suggestion that a more detailed analysis is extended to man-made and natural geo-physical phenomenon that are gargantuan in size in order to take advantage of the scaling effect that size has on the generation of significant electric power.

In a study conducted by authors in the “Pit Power Tower” paper the general design was developed and novel methods for focusing and collecting concentrated solar energy from open pit mines were studied. The study confirmed the feasibility of economically harnessing solar energies for a solar rankine cycle power generation system that could then be integrated with the proposed invention.

This invention is the result of an analysis and more detailed design that was produced by the inventors in preparation of that ASME 2003 paper.

### SUMMARY OF INVENTION

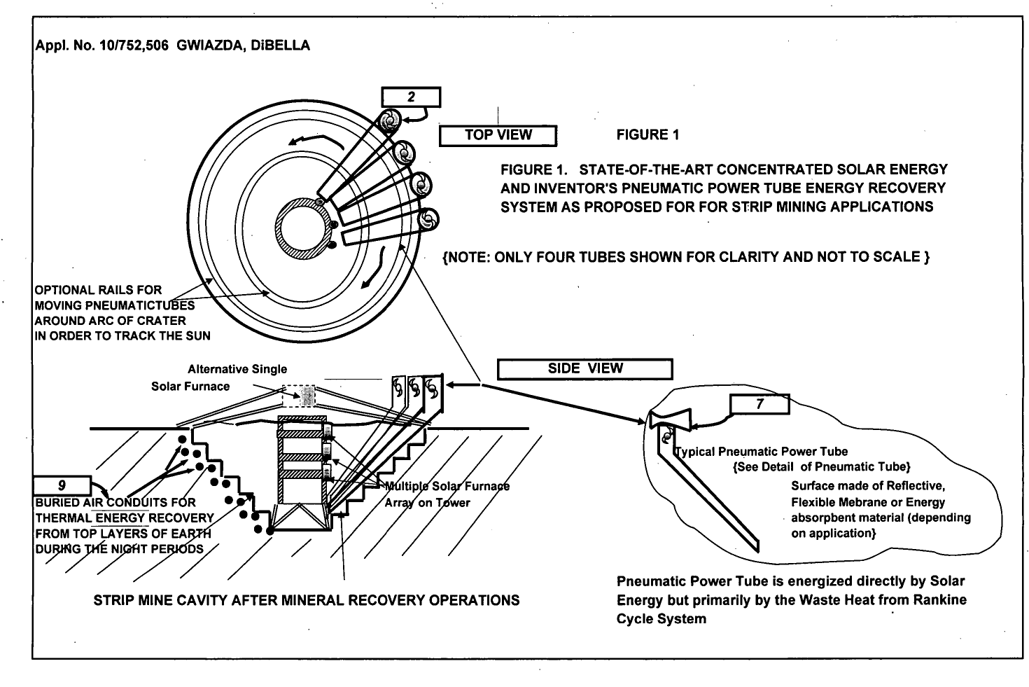

The invention consists of integrating a novel design for a Pneumatic Power Tube (PnPT) with a solar power rankine (or other heat engine with available waste heat energy) in an open-pit or other very large scale, man-made or natural occurring geo-physical phenomenon that the power generations system uses for economical structural support. The proposed pneumatic power tube that can produce a continuous air flow to generate significant electric power generation via waste heat recovery from a variety of sources, including but not exclusively: solar energy, by integrating it into an existing, massive man-made object: an open-pit mine. The novel design can eliminate the cost of constructing a freestanding column while also providing an environmentally friendly solution to the problems associated with decommissioning such mines. A schematic of the proposed Pneumatic Power Tube for the open-pit mine application is shown in FIG. 1 above. Similar wind power applications using pneumatic tube designs for large, naturally occurring geo-physical phenomenon such as very deep mountainous chasms are also feasible and are claimed.

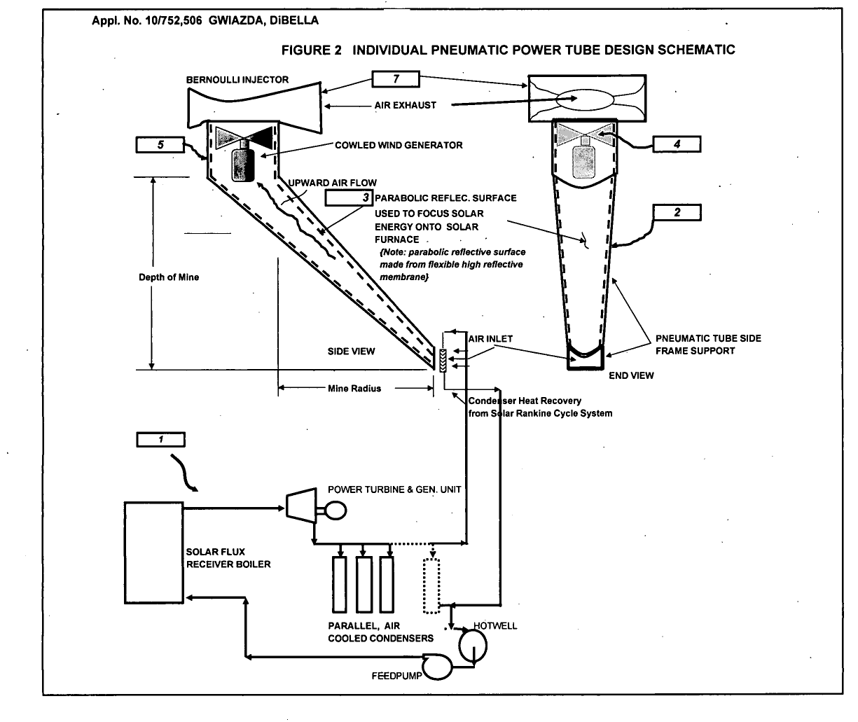

The pneumatic tube design that can be used in this application is shown in FIGS. 1 and 2 above. This novel design for the pneumatic tube provides many unique features that add to its usefulness in producing wind energy from rejected heat. (Numbers refer to system components shown in FIGS. 1 and 2)

1. The integrated pneumatic power tube and rankine (or other heat engine) is conceived to recover the wasted energy from the heat engine and the ground source heat thermally stored and/or generated naturally from geothermal energy.

2. The pneumatic tube can be structurally supported by the sides of the open-pit mind and thus avoid the costly structural engineering and materials that would otherwise be required to make it a free standing column,

3. The outside, top surface of the pneumatic tube is constructed of reflective (but also flexible) surfaces that enable that surface to be used as part of the reflectors that focus solar energy onto the receivers,

4. The pneumatic tubes are wider at their top than at the bottom thus forming a diffuser for the induced air flow that can recover static pressure at the inlet to the wind turbines while also controlling the air velocity to reasonable (lower) speeds,

5. The outlet of the pneumatic tubes can provide a cowling of the wind turbine(s) and thus improve the efficiency of the wind turbine,

6. The pneumatic tubes can be used to recover solar influx energy (i.e. transmitted energy) that is not reflected to the receivers. This energy can thus be used to provide additional heat to the air column and thus further induce airflow inside the pneumatic tubes,

7. The exhaust outlet of the pneumatic power tube can be fitted with a converging-diverging nozzle (venturi) to produce a Bernoulli effect at the exit of the wind turbine. This will help reduce the pressure at the turbine exhaust by utilizing the wind velocities at the top of the open-pit mines.

8. The structural support of the pneumatic tubes can also enable the pneumatic tubes to be made mobile in order to better focus or adjust the foci of the incident solar energy as the sun's inclination changes during the day or simply for simplicity and least cost for manufacturing many of the same (modularity concept) units,

9. The pneumatic tube design also enables heat recovery from heat storage via the gravel and ground surfaces of the open-pit mine. The heat can be recovered using easily buried air conduits and allowing the recovered air to be directly used in the pneumatic tubes. For example, heat pipes can be imbedded in the ground, in deep hot water springs or volcanic locales with chasms or fissures in order to recover the natural heat energy available from these natural phenomena.

### BACKGROUND PRIOR ART

It is well known that a very tall, high temperature air—filled conduit will have its top opening at lower atmospheric pressure and temperature than the opening at ground level.

This is commonly experienced and utilized to produce air drafts as an effective means of removing exhaust gases from combustion boilers. The air draft is induced by the differences in air density inside and outside the air column. Air density is significantly affected by temperature (hence the easily created air drafts in hot chimneys). Air is also a very compressible fluid where in the air's density is greatly affected with pressure. The atmospheric pressure, typically quoted as 14.696 psia, is only correctly stated for sea level. In fact, the air pressure at elevations greater than 1,000 ft. or below sea level can be as much as 0.25 to 0.5 psi greater.

Increasing the air temperature, decreases the density of the air column achieves the desired effect: that of establishing more of a pressure differential across the inlet and outlet of the pneumatic conduit. The addition of heat certainly requires energy consumption unless, as the authors' patent disclosure claims, it can be recovered from an otherwise wasted energy source. The recovery of wasted energy from a solar energy resource or wastes that are to be destroyed or ground source heat energy is particularly attractive given the typically high cost of solar energy systems, the cost or remediation of waste products and enormous potential energies that remain untapped for lack of an economically viable waste heat recovery system. Any attempt to generate more power without a proportional increase in cost would be beneficial to the economics of the solar energy system.

Of particular relevance to the present study is an interesting design concept suggested by Prof.s Gutman, Horesh, Gueta and Borschevsky, who are faculty at the Israel Institute of Technology. The basic concept for their power generation system was originally suggested by Mr. Peter Carlson in the 1970's (U.S. Pat. No. 3,894,393) and a recently published text: The Solar Chimney, by Jorg Schlaich (ISBN 3-930698-69-2). The power tower, called the Aero-Electric Power Tower is in the proposal development phase.¹ The Aero-Electric Power Tower is an enormous (1200 m high, 400 m diameter), freestanding, vertical tube, in which dry air is cooled via water injection to induce a downdraft of dense, moist air. The draft is passed through turbines at the bottom of the air column to generate electricity. The motive force for this air tower is the use of very dry (desert) air that can be continuously sprayed with water and thus saturated (humidified). The cooled, moist air flow flows downward through the tower and the increasing kinetic energy of the air stream is converted into electrical power via an array of turbines that are installed in the base of the tower where the air exhausts from the system. The inventors suggest that as much as 380 MW of power may be generated form such an arrangement. It is also important to note that the present inventors proposed Pneumatic Power Tubes work by heating the air and creating an updraft as opposed to the downdraft created in an Aero-Electric Tower. Most importantly, the present invention eliminates the need for the air column to be freestanding under its own, costly structural integrity. Rather, the support for the proposed pneumatic tube is via the previously (man-made) constructs and/or naturally occurring geophysical phenomenon while recovering the renewable energies that are available in that locale using the invention's several uniquely integrated design features.
¹Control of the Aero-Electric Power Station—an exciting QFT application for the 21st Century; Israel Institute of technology, Haifa 32000 Israel

All previous attempts at producing power from an air chimney have failed due to either the size constraint imposed by reasonable safe engineering practice and consequently a significant reduction in power output (making the magnitude of power virtually insignificant) or the extremely high cost required for overcoming the safety issues as well as the cost for gaining environmental permits and public sanctions.

Proposed Invention Pneumatic Power Pit Tube (PPPT) Concept and Applications:

The proposed invention is most suitable, but not exclusively, for combining a Pneumatic Power Tower and a Solar Power Tower in an open-pit (ore) mine (See FIG. 2).

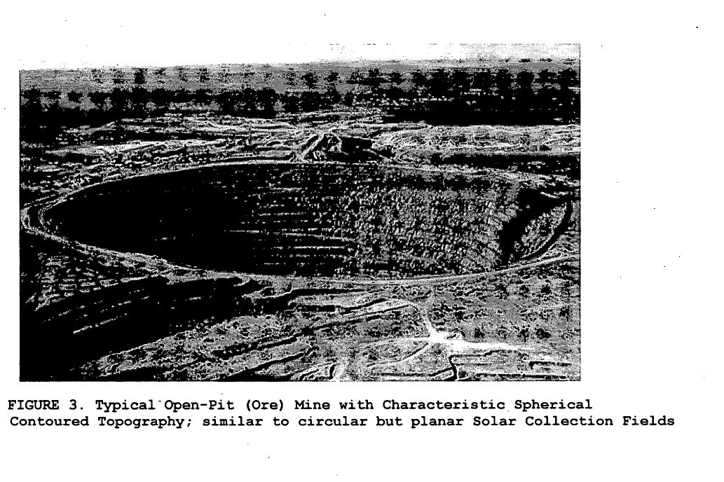

An open-pit mine is essentially a big hole in the ground as shown in FIG. 3. The mining method extracts minerals by blasting, excavating, and processing. The shape of the footprint of the mine takes depends on the most economical removal of the mineral, but the holes themselves generally take on a parabolic bowl shape as shown in FIG. 3. The sides of the mine are terraced with berms to prevent landslides and to provide level road surfaces that can lead up and out of the mine.

Solar energy is concentrated by the reflectors (similar to state-of-the-art field arrays of parabolic heliostat) onto a receiver. Molten salt is used as a working fluid to transfer the heat from the receiver to steam generators. Steam turbines then generate electricity. The rejected heat after the steam turbines is vented into the bottom of the pneumatic tubes creating an updraft, which passes through wind turbines in the tubes generating more electricity. During the last three decades considerable effort has also been expended to design, build and demonstrate the feasibility and cost effectiveness of Solar Power Towers. However, it is important to note that all of the Solar Power Towers that have been built (for example: Solar One and Solar Two Projects in Barstow, Calif. and others) have had their feasibility demonstrated on large flat surfaces. No one has contemplated installing SPT's in previously excavated or naturally formed, conically sectioned cavities or very deep vertical shafts.

### OBJECTS AND ADVANTAGES OF INVENTION

The proposed invention for this patent proposes the unique integration of a Solar Power Tower and a Pneumatic Power Tower (seen in detail in FIG. 2) and as shown installed in an open pit mine as shown schematically in FIG. 1 with a actual open-pit mine shown in FIG. 3. This integration of systems has many attractive economic incentives as well as power generation advantages. Consider:

1. An open-pit mine that is scheduled for decommissioning requires considerable expenditures to safely secure the area for subsequent reclamation by nature. Such expenditure however includes considerable maintenance to prevent the site from becoming hazardous from the accumulation of contaminated water,

2. Open pit mines are generally parabolic. A parabola has a higher focal power than a flat plane,

3. An open-pit mine that has been in operation for decades usually has an established infrastructure that can be utilized to support site workers who will maintain the new solar power generation facility,

4. The use of an existing Open-pit mine eliminates the need to purchase virgin land areas and/or petition the local citizenry for the establishment of a solar power site at the mine. The acquisition of land is usually a very expensive and time-consuming activity if environmental permits must be obtained,

5. The PPPT keeps the mine property productive after the mining life cycle and could potentially provide a means to clean the mine of pollutants. The reutilization of an open-pit mine for purposes of providing solar power, electric power generation is considered a more reasonable end-use of the land than allowing the developed site to degrade.

The proposed pneumatic power tube applied to open-pit mines is seen to be an effective application of several well-developed technologies: wind turbines, solar concentrated energy via Rankine Cycle power systems, thermal energy storage using rock and gravel medium and the transportation of electric power using AC-DC-AC converters and/or microwave power generation and transmission for very remote sites. All of these technologies have been under developed by a variety of research activities that have been supported by private and public funding and for which there have been remarkable strides forward in improving efficiencies while reducing costs. The deployment of a pneumatic power tube in depleted and decommissioned open-pit mines is seen as a perfect match of environmental concerns with state-of-the-art engineered, power systems

Thermodynamic Analysis: Integrated Pneumatic Power Pit Tube and Concentrated Solar Energy System for Open-Pit Mines

An analysis was conducted to determine the power that could be recovered from a pneumatic power tube that has been installed in an open pit mine and powered by heat rejected from a solar concentrated, Rankine Cycle system. This analysis is considered to be a first order estimate of the power recovery potential of the solar energy-Pneumatic Power Tower-open-pit mine installation. The analysis proceeded in three steps:

1. Determine the amount of pressure differential that can be produced by a column of air that is 1,000 to 3,000 ft. below sea level on earth (i.e. in the bottom of an open-pit mine),

2. 2. Determine the amount of mass flow rate and the velocity of air that can be induced by this pressure differential assuming that the flow is a simple Darcy-type friction flow in a large conduit,

3. Determine the power that is therefore recoverable assuming that the heat rejected by the condensers of a Rankine Cycle system heats the pneumatic power tube columns. The Rankine Cycle is powered by solar energy in a conventional concentrated solar heated system.

In order to determine the power recovery a special spreadsheet thermodynamics model of the concentrated solar Rankine Cycle system was prepared and a parametric study conducted to determine the effects of mine height and diameter on the recoverable power.

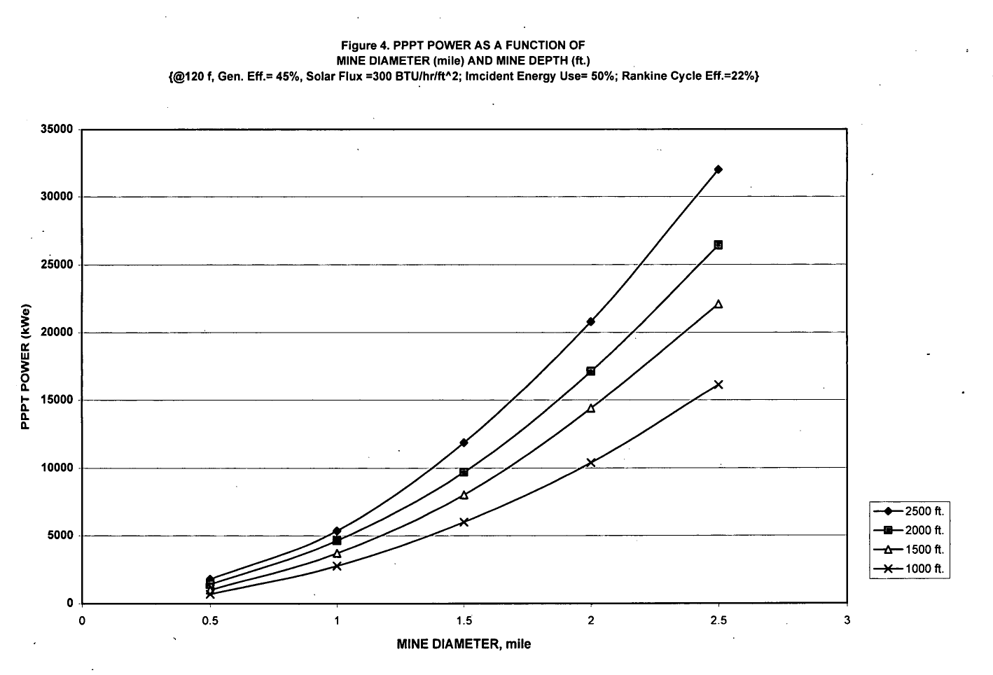

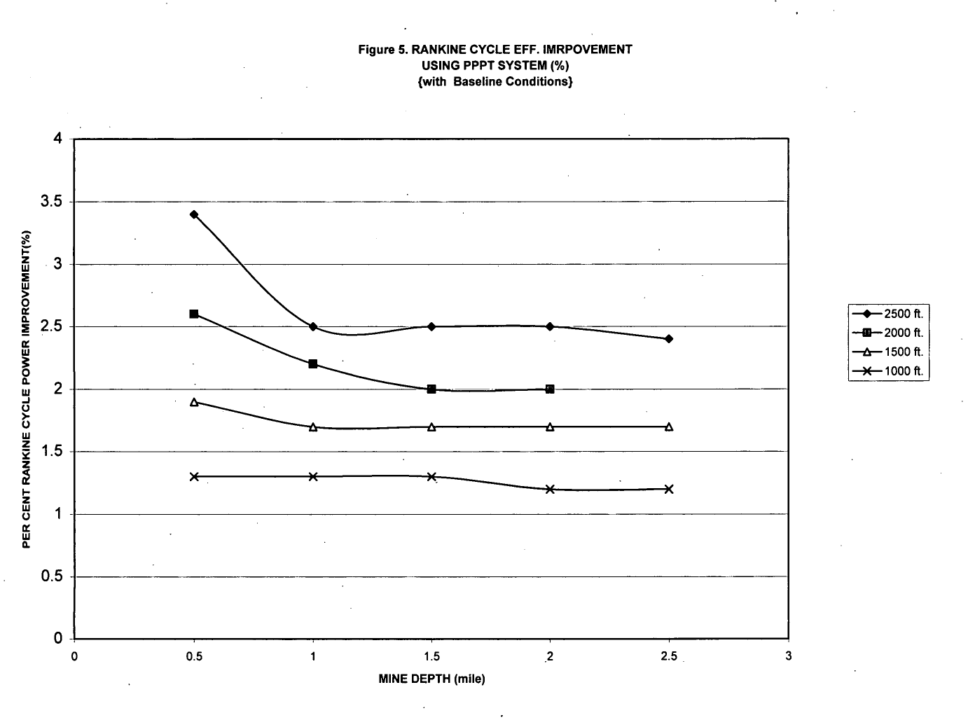

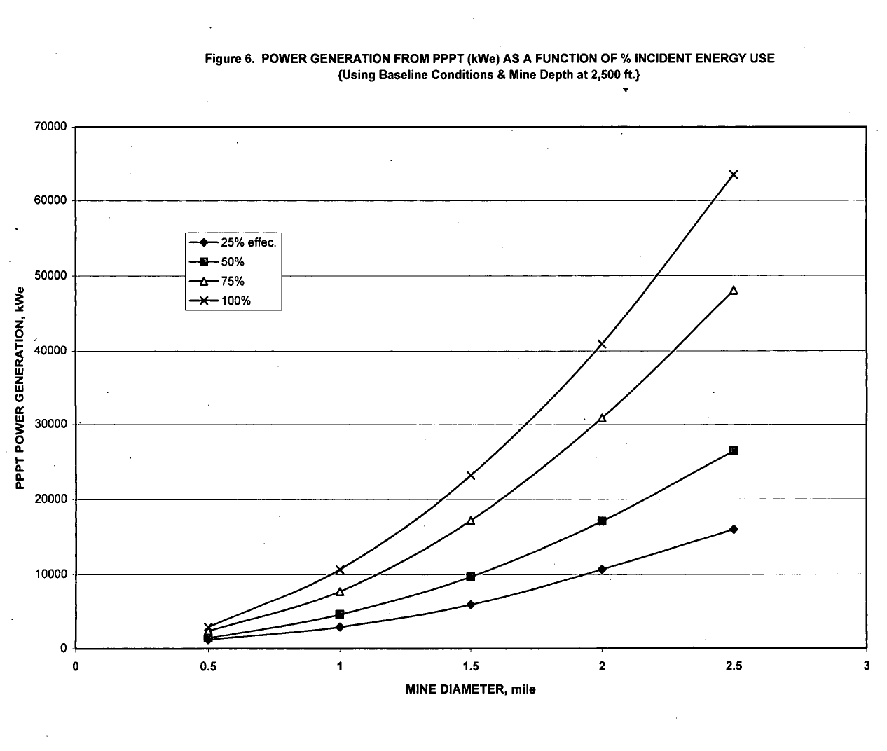

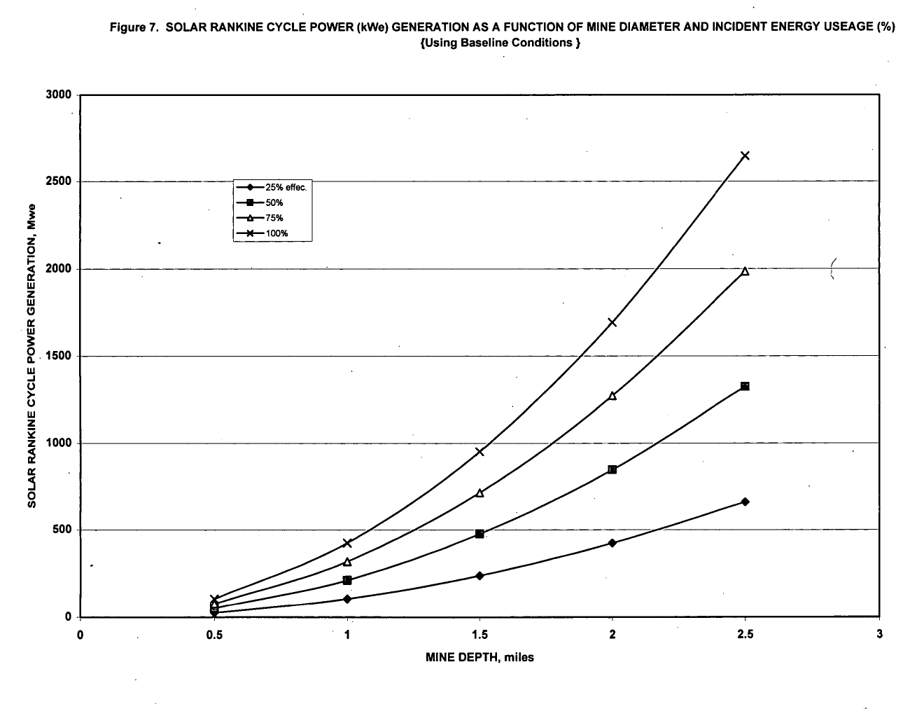

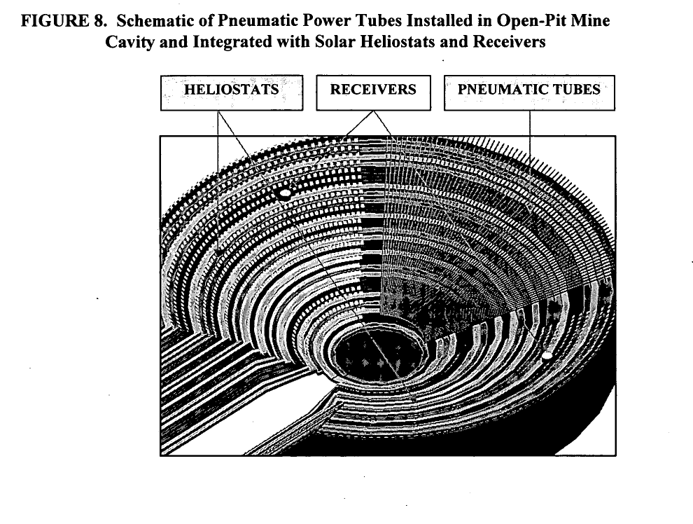

The results of a parametric study are shown in the attached Tables and Graphs. The Baseline Condition uses: 120 F PPPT internal air temp. a solar incident flux of 300 BTU/hr/ft², a Solar Rankine Cycle efficiency of 22% (and thus a 78% rejection eff. to the PPT system) and an effective incident energy land usage of 50%. The later parameter is an attempt to determine the fraction of the projected land area or the fraction of incident solar energy can be effectively recovered. The results indicate a power generation capability from the PPT that can range from 1 Mwe to 30 Mwe (FIG. 4) which represents approximately a 2 to 3% improvement in the Solar Rankine Cycle system efficiency (FIG. 5). This power is in addition to the approximately 50 Mwe and 800 Mwe of power that could be generated by the Solar Rankine Cycle system using concentrated solar reflectors and receivers of conventional design. It is interesting to compare this power improvement with the 2% overall cycle efficiency that is expected for the OTEC Systems (Ocean Thermal Energy Conversion) that have been considered as a viable alternative solar energy power generation system. The proposed PPPT system is thus seen to be comparable to OTEC systems with far less fabrication problems and associated costs. FIG. 7 identifies the effect of the “Incident Energy Usage Factor” on the power generation capability of the PPPT system.

### CONCLUSION

A typical open pit mine (the Palabora mine in South Africa) is shown in FIG. 3. The enormity of this open-pit mine is not unusual for such mining operations. Using the thermodynamic model that has been developed for this study and the dimensions of the mine and its geographic location (and thus knowing the solar flux at the site) an estimate can be made of the amount of power generation that can be produced at the site if it were to have an integrated solar Power and Pneumatic Power Pit Tube system installed. Using present specifications for concentrated solar energy power improvements from D.O.E. supported research (approximately 22% overall conversion efficiency) would enable 142 Mwe of electricity to be recovered from the Palabora mine once it was converted to a concentrated solar collector system using fixed (and not tracking), flat-plates (and not parabolic ally shaped) reflectors. Given that the site is already conically and perhaps even slightly parabolically shaped, geo-physical reconstruction could be minimal.

In place of the traditional mirrored reflectors, the sloped surface of the open-pit mine could be lined with flexible membranes that have high reflectivity. The shape of the mine may need some alterations to have the focal point for the resulting geometry to be made more precise but the tradition high cost of tracking heliostats, land acquisition and time consuming environmental permitting (to satisfy “not-in-my-back-yard” neighbors) and the construction of power production and staging building and facilities has been largely eliminated or greatly reduced. This should result in a lower cost per kW, reduced permitting and construction time and a productive use of what otherwise may have been unused and unattractive land area.

Similar large open pit mines are in operation but will eventually being decommissioned in some manner. For example, a larger open-pit mineral mine: the Chuquicamata Mine is 2×3 km wide and 810 meters deep and could produce as much as 734 Mw of Solar Rankine Power plus an additional 18 Mwe of power from the PPPT system. The deepest mine in the world: The Western Deep Gold Mine is located in South Africa. Its depth of 4,000 meters would enable cold ventilation air from the surface to be naturally heated by the earth to over 100 F (38 C). The thermally induced air draft from this mine could serve as the largest prototype of the nature-draft wind tower concept promoted in this paper.

Whether such enormous man-made or natural phenomenon use the proposed wind towers as presented in this paper or one of many solar energy recovery methods or even the neutralization of acidic, contaminated standing water via anode-cathode electric cells will be the subject of a third in this series of technical papers on natural energy resource recovery and generation. For example, air towers made from extinct and voided volcanoes or mountains (i.e. abandoned mines with vertical air chutes that connect 2,000⁺ ft. deep chasms with the upper atmosphere may serve as a Natural induced air tower.

The authors have formulated a design to enhance the recover of concentrated solar energy in high temperature receivers while also enabling land reclamation and effectively re-utilizing of decommissioned open-pit mines.

The proposed novel design effectively recovers the kinetic and pressure potential energies of the thermally induced air drafts by providing the thermal energy input from the wasted heat of a Solar Rankine Cycle system. The proposed (nominal) 600+meter long×15 meter dia. pneumatic power tubes are supported by the floor of the decommissioned, open-pit mine; mines that are typically 1,500 meters in diameter and 600 meters deep. The design utilizes the concept of wind power generation using a thermally induced flow of air also known as a chimney or draft-induced airflow. Thermal induced drafts have been studied in the past by DOE and other researchers and have been found to successfully induce sufficient quantities of air and thus enable efficient power generation using wind turbines. This prior art however required that the chimney structures be enormously tall structures, typically over 2,000 ft tall for the induced air drafts to be sufficient for useful utility-size power generation. However, the tall, freestanding air columns are expensive to construct and thus negates the economic viability of the solar power generation.

The proposed system is unique in the field of power generation. The proposed system effectively uses previously developed high temperature, solar energy receiver technologies and improves the Solar Rankine Cycle efficiency by recovering the rejected condenser heat while also providing a solution to the reclamation and utilization of depleted open pit mines. In place of the traditional mirrored reflectors, the sloped surface of the open-pit mine will be lined with a pneumatic power tube of original design that includes a reflective top surface for focusing the solar energy while also diffusing the induced air flow to produce both kinetic as well as potential (pressure) energy recovery via high efficiency wind generators that have been designed with cowling to reduce air by-pass.

1. A renewable energy power plant fundamentally consisting of a concentrating solar rankine cycle or other thermodynamic heat engine cycle with waste heat rejection and a pneumatic tube that is structurally supported by the sides of the open-pit mine or other man-made deep phenomenon and thus avoid the costly structural engineering and materials that would otherwise be required to make it a free standing column,

1a. The said tube can be also supported by and/or installed into naturally formed geophysical chasms and fissures that will provide the external structural support required for the said tube.

1b. Said renewable energy plant and pneumatic tube, wherein the system uses an interlocking support structure consisting of the said pneumatic tubes and/or heliostat structures to fortify the open pit embankments while also protecting said system from earth slides

1c. A renewable energy plant as claimed in 1 (a & b) that places a plurality of modular solar thermal receivers at various foci within the open volume in order to receive a maximum of reflective incident solar energy.

2. The outside, top surface of said tube that is constructed of reflective and also flexible surfaces that enable that surface to be used as part of the reflectors that focus solar energy onto the receivers,

3. The said tubes are designed to be wider at their top than at the bottom thus forming a diffuser for the induced air flow that can recover static pressure at the inlet to the wind turbines while also controlling the air velocity to reasonable (lower) speeds which enables wind turbines to operate more efficiently,

3a. The outlet of the said tubes are to be provided with cowling for the wind turbine(s) and thus improve the efficiency of the said turbines,

4. The said tubes are to be used to recover transmitted solar influx energy that is not reflected to the receivers. This energy can thus be used to provide additional heat to the air column and thus further thermally induce airflow inside the said tubes,

5. The said tubes are to be installed in a similar manner for structural support while recovering the wasted heat energy from the condenser of a Solar Rankine Cycle system,

5a. The said tubes can also recover heat energy via heat pipes that are installed into the earth' energy that is a direct consequence of earth's conduction and/or convection of heat energy from below the ground toward the surface,

5b. The said tubes can also be used to recover the energy from exhaust gases from the combustion of local waste disposal where said wastes are resulting from man-made processing or naturally occurring organic, carbon-based materials.

6. The exhaust outlet of the said tube can be fitted with a converging-diverging nozzle (venturi) to further reduce the static pressure via the Bernoulli effect at the exit of the wind turbine and thus improve the energy efficiency and power output of said turbines while recovering the surface wind velocities at the top of the open-pit mines.

7. The design of said tubes having been designed to be structurally supported by the man-made or naturally occurring phenomenon will be designed to be modular in size so as to enable their use in a variety of applications where the magnitudes of the waste heat energy is several magnitudes above or below the heat recovery values cited in this application.

7a. The modularity of the said tube can also facilitate the shipment to and installation in a variety of locales.

8. The said tube design also enables heat recovery from heat storage via the gravel and ground surfaces of the open-pit mine and other natural geo-physical phenomenon. The heat can be recovered using easily buried air conduits and allowing the recovered air to be directly used in the pneumatic tubes.

9. A renewable energy power plant as recited in claim 1, wherein the said cogeneration system partially embeds the solar thermal receivers in the embankment to use the soil to improve thermal insulation by:

9a. providing a windshield, and

9b. to use the soil as thermal convection attenuator.

10. A renewable energy power plant as recited in claims 1b, wherein the said cogeneration system embeds the pneumatic tubes completely in the embankments to provide:

10a. thermal insulation for the pneumatic tubes, and

10b. by interlocking the pneumatic tubes as described in claim 1b to provide a support structure to the embankments.

11. A renewable energy power plant as recited in claim 1, wherein the said cogeneration system uses the pneumatic tubes as a condenser system thereby reducing the size of the said cogeneration system's condenser or replacing the said condenser completely.

12. A renewable energy power plant as recited in claims 11, wherein the said cogeneration system uses the gravitational kinetic energy of the condensed water in said pneumatic tubes condenser system flowing out at the bottom after condensation to generate electricity.
